(19) United States
(12) Patent Application Publication
(10) Pub. No.: US 2009/0096464 A1
(43) Pub. Date: Apr. 16, 2009

(54) Electrical leakage detecting device for a fuel cell system

(76) Inventors: Hideyuki Tanaka, Aichi-ken (JP); Shuji Hirakata, Susono-shi (JP); Tatsuaki Yokoyama, Susono-shi (JP)

Correspondence Address: Locke Lord Bissell & Liddell LLP;Attn: IP Docketing, Three World Financial Center, New York, NY, 10281-2101, US

(21) Appl. No.: 12/286,935

(22) Filed: Oct. 3, 2008

(30) Foreign Application Priority Data
Oct. 4, 2007 (JP) 2007-260797

(51) Int. Cl. G01N 27/00

(52) U.S. Cl. 324/551

(57) ABSTRACT

An electrical leakage determining circuit determines the occurrence of electrical leakage at a negative electrode of a fuel cell when a potential difference V between a positive electrode of the fuel cell and ground, which is detected by a potential difference detecting circuit, exceeds a preset potential difference threshold Vth, and determines the occurrence of electrical leakage at the positive electrode of the fuel cell when an insulation resistance R between the positive electrode of the fuel cell and ground, which is detected by a resistance detection circuit, falls below a resistance threshold Rth preset to be equal to or smaller than a resistance value Rw of a coolant. Upon determination of the occurrence of electrical leakage, the electrical leakage determining circuit opens a switching contact provided on a power supply line to interrupt power supply from the fuel cell to various power consumption components.

### BACKGROUND OF THE INVENTION

1. Field of the Invention

The present invention relates to an electrical leakage detecting device for a fuel cell system, and particularly, to a device for detecting electrical leakage from the fuel cell system which supplies electric power by connecting a pair of electrodes of a fuel cell to electric power supply lines respectively corresponding thereto.

2. Description of the Related Art

In recent years, fuel cell vehicles in which a fuel cell is mounted as a power source have been developed. Fuel cells generate electricity using a chemical reaction between hydrogen and oxygen, but for on-vehicle use, a plurality of cells are connected in series to generate high voltage of 300 volts or more, so measures are taken against electrical leakage.

For instance, JP 2006-100005 A proposes an apparatus in which an intermediate potential electrode is provided in a fuel cell, and potential difference between ground and the intermediate potential electrode is measured to detect electrical leakage. When electrical leakage occurs and a leakage current flows, the potential difference between ground and the intermediate potential electrode increases, whereby occurrence of the electrical leakage is detected by detecting this increase in potential difference.

### SUMMARY OF THE INVENTION

However, in order to provide an intermediate potential electrode in a fuel cell, as shown in FIG. 5, two cell stacks S1 and S2 in which a plurality of cells are stacked in series must be arranged in two rows so that the polarities on each side of the cell stack S1 are opposite to the polarities on each side of the cell stack S2, and so that electrodes at one end portion of the cell stacks S1 and S2 be respectively made to be a positive electrode P and a negative electrode N for this fuel cell, and electrodes at the other end portion of the cell stacks S1 and S2 be electrically connected to each other to form an intermediate potential electrode M therein. This leads to an increase in the number of components, size, man-hours manufacturing, cost, mass, or the like of the fuel cell.

The present invention has been made in view of the aforementioned problem, and an object is to provide an electrical leakage detecting device for a fuel cell system, capable of detecting electrical leakage in the fuel cell system even if an intermediate potential electrode is not provided in a fuel cell.

According to the present invention, an electrical leakage detecting device for a fuel cell system, for detecting electrical leakage from the fuel cell system which supplies power by connecting a pair of electrodes of a fuel cell to power supply lines respectively corresponding thereto, includes: an electrical resistance device connected between one of the pair of electrodes and ground, and having a predetermined resistance value; a potential difference detecting circuit for detecting a potential difference between the one of the pair of electrodes and ground; a resistance detecting circuit for detecting an insulation resistance between the one of the pair of electrodes and ground; and an electrical leakage determining circuit for determining an occurrence of the electrical leakage at the other of the pair of electrodes when the potential difference detected by the potential detecting circuit exceeds a preset potential difference threshold, and for determining the occurrence of the electrical leakage at the one of the pair of electrodes when the insulation resistance detected by the resistance detecting circuit falls below a resistance threshold preset to be equal to or smaller than the predetermined resistance value.

### BRIEF DESCRIPTION OF THE DRAWINGS

In the accompanying drawings:

FIG. 1 is a diagram showing an equivalent circuit of a fuel cell system including an electrical leakage detecting device according to a first embodiment of the present invention;

FIG. 2 is a diagram showing a state in which electrical leakage has occurred at a negative electrode of a fuel cell in the first embodiment;

FIG. 3 is a diagram showing a state in which electrical leakage has occurred at a positive electrode of the fuel cell in the first embodiment;

FIG. 4 is a diagram showing an equivalent circuit of a fuel cell system including an electrical leakage detecting device according to a second embodiment of the present invention; and

FIG. 5 is a diagram showing a fuel cell of a conventional dual cell stack type, in which an intermediate potential electrode is provided.

### DETAILED DESCRIPTION OF THE PREFERRED EMBODIMENTS

Hereinafter, embodiments of the present invention are described with reference to the drawings.

### First Embodiment

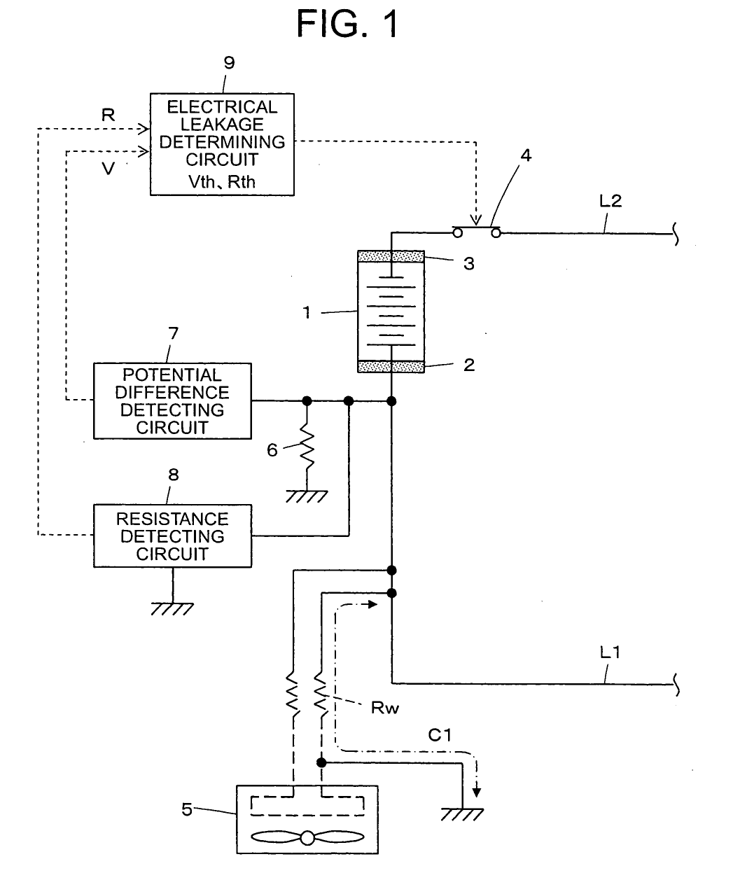

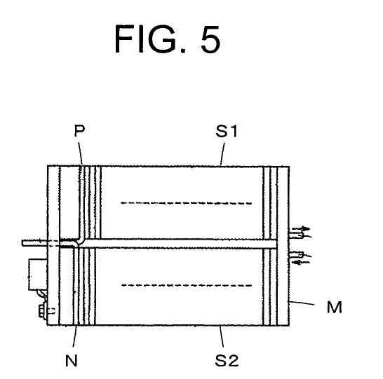

FIG. 1 shows a structure of an on-vehicle fuel cell system including an electrical leakage detecting device according to a first embodiment of the present invention. In a fuel cell 1, end plates 2 and 3 made of a conductive metal are arranged at both ends of a single cell stack in which a plurality of cells are stacked in a row so that polarities thereof are made to be in the same direction, but in which an intermediate potential electrode of a fuel cell, as shown in FIG. 5, is not provided. One end of the cell stack is set to be a positive electrode, and the other end thereof is set to be a negative electrode. In the first embodiment shown in FIG. 1, the end plate 2 and the end plate 3 are electrically connected to the positive electrode and the negative electrode, respectively. Further, various power consumption components (not shown) such as a driving motor, a power steering apparatus, an air compressor, and air conditioning equipment of a vehicle are connected to the positive electrode and the negative electrode of the fuel cell 1 via a power supply line Li and a power supply line L2, respectively. Note that a switching contact 4 is provided on the power supply line L2 connected to the negative electrode of the fuel cell 1.

A coolant is circulated and supplied to the fuel cell 1 to prevent a decrease in power generation efficiency, which is caused due to heat generation during a chemical reaction between hydrogen and oxygen in each cell. An inlet (not shown) and an outlet (not shown) are formed in the end plate 2 at one end of the fuel cell 1, and a coolant passage is formed in the cell stack so that the inlet is communicated with the outlet. A radiator 5 is connected to a circulating pump (not shown) via piping between the inlet and the outlet of the end plate 2. By driving of the circulating pump, the coolant flows from the inlet of the end plate 2 of the fuel cell 1 to the cell stack, flows through the coolant passage of the cell stack and flows out of the outlet. The coolant is then air-cooled by the radiator 5 to be recirculated to the fuel cell 1.

At this time, the coolant flows through the inlet and the outlet to be in contact with the end plate 2 connected to the positive electrode of the fuel cell 1 and also to be electrically connected to ground in the radiator 5 or in the vicinity of the radiator 5. This means that the positive electrode of the fuel cell 1 is electrically connected to ground via the coolant. In other words, the coolant forms an electrical resistance device connected between the positive electrode of the fuel cell 1 and ground. FIG. 1 shows a resistance value Rw of the coolant.

A resistor 6 for measuring a potential difference is connected between the positive electrode of the fuel cell 1 and ground. A potential difference detecting circuit 7 is connected to the resistor 6. In addition, a resistance detecting circuit 8 is connected to the positive electrode of the fuel cell 1. The potential difference detecting circuit 7 detects the potential difference between the positive electrode of the fuel cell 1 and ground. The resistance detecting circuit 8 detects the insulation resistance between the positive electrode of the fuel cell 1 and ground. An electrical leakage determining circuit 9 is connected to the potential difference detecting circuit 7 and the resistance detecting circuit 8.

In the electrical leakage determining circuit 9, a potential difference threshold Vth and a resistance threshold Rth are preset. The electrical leakage determining circuit 9 determines the occurrence of electrical leakage at the negative electrode of the fuel cell 1 when a potential difference V detected by the potential difference detecting circuit 7 exceeds the potential difference threshold Vth, and determines the occurrence of electrical leakage at the positive electrode of the fuel cell 1 when an insulation resistance R detected by the resistance detecting circuit 8 falls below the resistance threshold Rth. Moreover, the electrical leakage determining circuit 9 controls opening or closing of the switching contact 4 provided on the power supply line L2 based on a judgment result of electrical leakage.

Note that the potential difference threshold Vth is set to, for example, a predetermined value slightly larger than 0, and the resistance threshold Rth is set to a predetermined value slightly smaller than the resistance value Rw of the coolant.

Next, an operation of the electrical leakage detecting device of the first embodiment will be described.

First, during normal operation in which there is no occurrence of electrical leakage, the switching contact 4 provided on the power supply line L2 is closed by the electrical leakage detecting circuit 9, and electrical power generated in the fuel cell 1 is supplied to the various power consumption components such as the driving motor, the power steering apparatus, the air compressor, and the air conditioning equipment of the vehicle via the power supply line L1 and the power supply line L2. Note that by driving the circulating pump (not shown), the coolant for cooling the cell stack of the fuel cell 1 is circulated between the fuel cell 1 and the radiator 5.

As there is no occurrence of electrical leakage, leakage current does not flow through the resistor 6 connected to the positive electrode of the fuel cell 1, and the potential difference V between the positive electrode of the fuel cell 1 and ground, which is detected by the potential difference detecting circuit 7, becomes approximately 0.

Further, as described above, because the positive electrode of the fuel cell 1 is electrically connected to ground via the coolant, the resistance detecting circuit 8 measures the insulation resistance of a path C1 along the flow of the coolant as the insulation resistance R between the positive electrode of the fuel cell 1 and ground, and detects the resistance value Rw of the coolant.

The potential difference V and the insulation resistance R, which are detected by the potential difference detecting circuit 7 and the resistance detecting circuit 8 in this manner, respectively, are input to the electrical leakage determining circuit 9.

The electrical leakage determining circuit 9 first compares the potential difference V detected by the potential difference detecting circuit 7 with the preset potential difference threshold Vth. At this time, the potential difference V detected by the potential difference detecting circuit 7 is approximately 0, and thus does not exceed the potential difference threshold Vth preset to the predetermined value slightly larger than 0. Accordingly, the electrical leakage determining circuit 9 determines that there is no occurrence of electrical leakage at the negative electrode of the fuel cell 1.

Next, the electrical leakage determining circuit 9 compares the insulation resistance R detected by the resistance detecting circuit 8 with the preset resistance threshold Rth. At this time, the insulation resistance R detected by the resistance detecting circuit 8 is equal to the resistance value Rw of the coolant, and thus does not fall below the resistance threshold Rth preset to the predetermined value slightly smaller than the resistance value Rw of the coolant. Accordingly, the electrical leakage determining circuit 9 determines that there is no occurrence of electrical leakage at the positive electrode of the fuel cell 1.

After determining that there is no occurrence of electrical leakage at the negative electrode and the positive electrode of the fuel cell 1, the electrical leakage determining circuit 9 maintains the switching contact 4 in a closed state, and makes it possible to supply electric power from the fuel cell 1 to the various power consumption components.

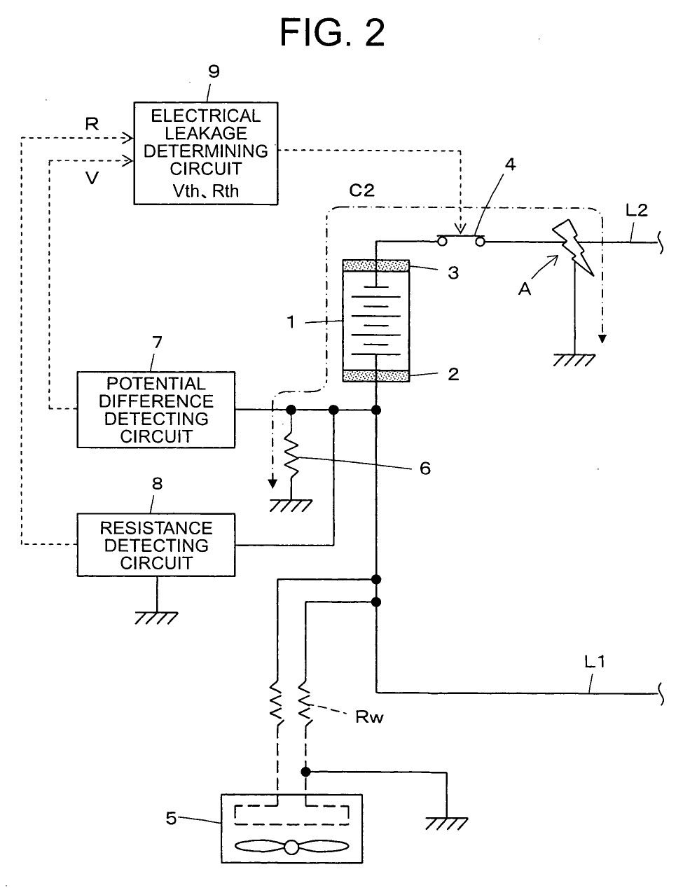

In this case, as shown in FIG. 2, when it is assumed that there is an occurrence of electrical leakage at a point A on the power supply line L2 connected to the negative electrode of the fuel cell 1, and that the point A is electrically connected to ground, a closed circuit is formed along a path C2 ranging from ground to ground via the point A, the switching contact 4 in the closed state, the fuel cell 1, and the resistor 6, and the leakage current flows through the closed circuit. As a result, in response to the leakage current flowing through the resistor 6, the potential difference V determined by the resistance value of the resistor 6 and the current value of the leakage current is generated between the positive electrode of the fuel cell 1 and ground, and this potential difference V is detected by the potential difference detecting circuit 7.

As the resistor 6, a resistor having a predetermined large resistance value is used so that a large potential difference V is generated even when a slight leakage current flows, and a potential difference V generated by the leakage current at this time is sufficiently larger than the potential difference threshold Vth set to the predetermined value slightly larger than 0.

Accordingly, the electrical leakage determining circuit 9 determines the occurrence of electrical leakage at the negative electrode of the fuel cell 1 from the fact that the potential difference V detected by the potential difference detecting circuit 7 exceeds the potential difference threshold Vth, and opens the switching contact 4 to interrupt power supply from the fuel cell 1 to the various power consumption components.

Note that, at this time, the insulation resistance R detected by the resistance detecting circuit 8 is equal to the resistance value Rw of the coolant as in the case of normal operation, and thus the electrical leakage determining circuit 9 can determine that there is no occurrence of electrical leakage at the positive electrode of the fuel cell 1.

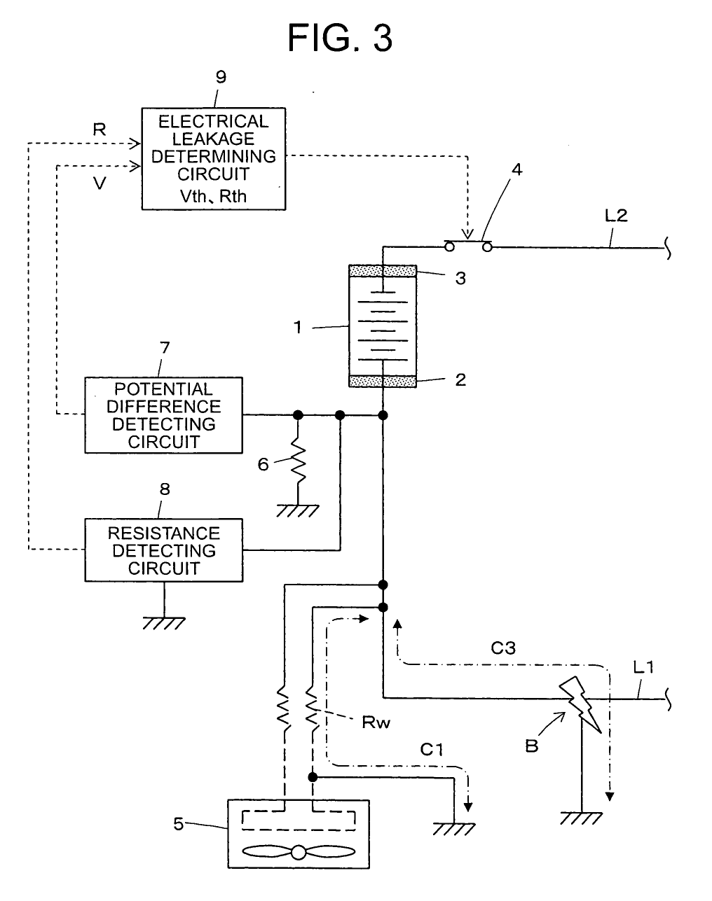

Next, as shown in FIG. 3, when it is assumed that there is an occurrence of electrical leakage at a point B on the power supply line Li connected to the positive electrode of the fuel cell 1, and that the point B is electrically connected to ground, the positive electrode of the fuel cell 1 is electrically connected to ground via the point B along a path C3, whereby a parallel circuit including the path C3 and the path C1 which is formed along the flow of the coolant is formed between the positive electrode of the fuel cell 1 and ground. As described above, the insulation resistance of the path C1 is equal to the resistance value Rw of the coolant, but an insulation resistance of the path C3, which is formed due to the occurrence of electrical leakage, is much smaller than the insulation resistance of the path C1, whereby the insulation resistance of the entire parallel circuit becomes smaller than the resistance value Rw of the coolant. As a result, the insulation resistance R between the positive electrode of the fuel cell 1 and ground, which is detected by the resistance detecting circuit 8, becomes sufficiently smaller than the resistance threshold Rth preset to a predetermined value slightly smaller than the resistance value Rw of the coolant.

Accordingly, the electrical leakage determining circuit 9 determines the occurrence of electrical leakage at the positive electrode of the fuel cell 1 from the fact that the insulation resistance R detected by the resistance detecting circuit 8 falls below the resistance threshold Rth, and opens the switching contact 4 to interrupt power supply from the fuel cell 1 to the various power consumption components.

Note that, at this time, the potential difference V detected by the potential difference detecting circuit 7 is approximately 0 as in the case of normal operation, with the result that the electrical leakage determining circuit 9 can determine that there is no occurrence of electrical leakage at the negative electrode of the fuel cell 1.

### Second Embodiment

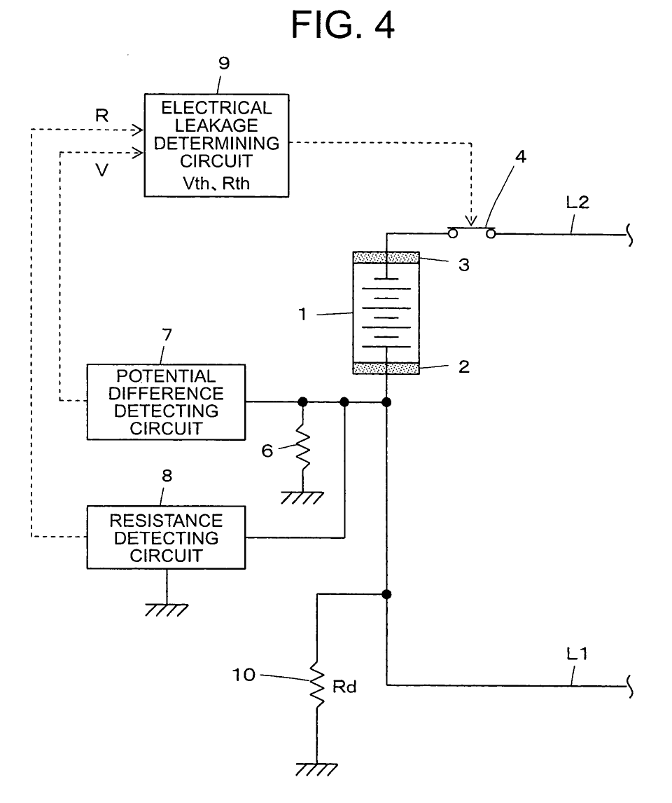

FIG. 4 shows a structure of an on-vehicle fuel cell system including an electrical leakage detecting device according to a second embodiment of the present invention. In the second embodiment, a resistor 10 having a predetermined resistance value Rd is connected between the positive electrode of the fuel cell 1 and ground to form an electrical resistance device in place of forming the electrical resistance device connected between the positive electrode of the fuel cell 1 and ground by the use of the coolant for cooling the fuel cell 1 in the device according to the first embodiment shown in FIG. 1. Note that, as the preset resistance threshold Rth in the electrical leakage determining circuit 9, a predetermined value slightly smaller than the resistance value Rd of the resistor 10 is selected.

Operation of the electrical leakage detecting device according to the second embodiment is similar to that of the first embodiment described above. In other words, the resistance detecting circuit 8 detects the resistance value Rd of the resistor 10 as the insulation resistance R between the positive electrode of the fuel cell 1 and ground during normal operation where there is no occurrence of electrical leakage, and detects the insulation resistance R smaller than the resistance value Rd of the resistor 10 in the case of occurrence of electrical leakage on the power supply line L1 connected to the positive electrode of the fuel cell 1. For this reason, the electrical leakage determining circuit 9 can detect the presence or absence of the occurrence of electrical leakage on the power supply line L1 by comparing the insulation resistance R detected by the resistance detecting circuit 8 with the preset resistance threshold Rth.

As described above, it is possible to independently detect the occurrence of electrical leakage at the negative electrode and the positive electrode respectively of a fuel cell 1 that is not provided with an intermediate potential electrode, to thereby interrupt power supply from the fuel cell 1 when the occurrence of electrical leakage is detected.

Since the fuel cell 1 does not have an intermediate potential electrode, the switching contact 4 only needs to be provided on the power supply line L2 at the negative electrode of the fuel cell 1, which is not connected to ground through the coolant, and does not need to be provided on the power supply line L1 at the positive electrode of the fuel cell 1, which is connected to ground through the coolant.

Accordingly, it is possible to reduce the number of switching contacts for interrupting power supply from the fuel cell, in addition to reduce the number of components, size, man-hours manufacturing, cost, mass, or the like of the fuel cell. For this reason, it is effective to apply the present invention to various vehicles onto which a fuel cell is mounted as the driving source, such as industrial vehicles including forklifts and other general vehicles.

Note that, in the first and second embodiments described above, the positive electrode of the fuel cell 1 is connected to ground via the coolant or the resistor 10, but the negative electrode of the fuel cell 1 may be connected to ground via the coolant or the resistor 10 by reversing the polarities of the fuel cell 1. Also in this case, in precisely the same manner, the electrical leakage detecting circuit 9 can detect the presence or absence of the occurrence of electrical leakage based on the potential difference between the negative electrode of the fuel cell 1 and ground, which is detected by the potential difference detecting circuit 7, and the insulation resistance between the negative electrode of the fuel cell 1 and ground, which is detected by the resistance detecting circuit 8.

Further, in the first and second embodiments described above, as the preset resistance threshold Rth in the electrical leakage determining circuit 9, a predetermined value slightly smaller than the resistance value Rw of the coolant or the resistance value Rd of the resistor 10 was selected, but the resistance threshold Rth can be set to an appropriate value equal to or smaller than the resistance value Rw of the coolant or the resistance value Rd of the resistor 10. When an electrical leakage occurs at the electrode of the fuel cell 1, which is connected to ground via the coolant or the resistor 10, the value of the insulation resistance detected by the resistance detecting circuit 8 decreases significantly, so a resistance threshold Rth, by which a decrease of the insulation resistance can be detected, is sufficient.

What is claimed is:

1. An electrical leakage detecting device for a fuel cell system, for detecting electrical leakage from the fuel cell system which supplies power by connecting a pair of electrodes of a fuel cell to power supply lines respectively corresponding thereto, comprising:
an electrical resistance device connected between one of the pair of electrodes and ground, and having a predetermined resistance value;
a potential difference detecting circuit for detecting a potential difference between the one of the pair of electrodes and ground;
a resistance detecting circuit for detecting an insulation resistance between the one of the pair of electrodes and ground; and
an electrical leakage determining circuit for determining an occurrence of the electrical leakage at the other of the pair of electrodes when the potential difference detected by the potential detecting circuit exceeds a preset potential difference threshold, and for determining the occurrence of the electrical leakage at the one of the pair of electrodes when the insulation resistance detected by the resistance detecting circuit falls below a resistance threshold preset to be equal to or smaller than the predetermined resistance value.

2. An electrical leakage detecting device for a fuel cell system according to claim 1, further comprising a switching contact provided on the power supply line connected to the other of the pair of electrodes,
wherein, when the occurrence of an electrical leakage is determined, the electrical leakage determining circuit opens the switching contact to interrupt the power supply from the fuel cell.

3. An electrical leakage detecting device for a fuel cell system according to claim 1, wherein the electrical resistance device comprises a coolant for cooling the fuel cell.

4. An electrical leakage detecting device for a fuel cell system according to claim 1, wherein the electrical resistance device comprises a resistor connected between the one of the pair of electrodes and ground.

5. An electrical leakage detecting device for a fuel cell system according to claim 1, wherein the electrodes of the fuel cell consist only of a pair of a positive electrode and a negative electrode.
